(19) United States
(12) Patent Application Publication
(10) Pub. No.: US 2006/0169218 A1
(43) Pub. Date: Aug. 3, 2006

(54) Pet car

(76) Inventor: Fong Chewn Chang, Huntington Beach, CA (US)

Correspondence Address: CHARLES C.H. WU, 98 DISCOVERY, IRVINE, CA, 92618-3105, US

(21) Appl. No.: 11/165,642

(22) Filed: Jun. 24, 2005

(30) Foreign Application Priority Data
Feb. 3, 2005 (JP) 2005-027701

(51) Int. Cl. A01K 1/03

(52) U.S. Cl. 119/496

(57) ABSTRACT

A pet carrying apparatus in which a pet can get in or out of a bag structure by itself is provided. The bag structure has a definite inner space defined by a bag body, a positioning frame that is positioned on a periphery the bag body, and a front layer defining a pet opening therein, whereby a pet can get in or out of the inner space. The apparatus further has a vehicle body that defines a vehicle inner space. The vehicle body has a frame and a set of attached wheels. The apparatus also has a pair of connecting devices positioned opposite of each other. Each of the connecting devices being located at an inner side of the vehicle body such that when the bag structure is placed within the vehicle inner space, the pair of connecting devices is symmetrically placed on the positioning frame.

### BACKGROUND OF THE INVENTION

1. Field of the Invention

The invention pertains to the field of pet related device. More particularly, the invention pertains to a pet carrying vehicle.

2. Description of Related Art

U.S. Pat. No. 6,866,008 describes a light-weighted, foldable, soft-sided pet conveyance apparatus. The apparatus provides a soft-sided containment area for securing a pet which can allow a pet to view its surroundings through an optional overhead. containment wall access opening or completely secure the pet with a closure flap. The containment area may be used in conjunction with a pre-existing stroller or may be disposed on a stroller frame as a single unit.

U.S. Pat. No. 5,113,793 describes a mobile animal carrier having a cage-like enclosure mounted on a specially-designed carriage with wheels and for holding and transporting the enclosure, the carriage having a handle to make pushing easy for the pet owner. The enclosure contains an access, preferably consisting of at least one door in a front end of the enclosure for inputting and removing a pet or other animal. A canopy is provided to cover the enclosure, said canopy having a fastener for adjustably opening the canopy as desired. The enclosure is designed to be removable from the carriage and collapsible for easy storage and transporting when not in use. Similarly, the carriage can be folded for easy storage and transportation as well.

U.S. Pat. No. 6,584,937 describes a pet transport system for taking small and vulnerable pets on outings. The pet transport system includes a carriage portion designed for holding a small animal, the carriage portion includes a bottom wall and four side walls extending upwardly from the bottom wall; a wheeled portion for rolling the system along a surface such as the ground, the wheeled portion is coupled to the bottom wall; a canopy portion coupled to at least one side wall of the carriage portion, the canopy portion provides shade for the animal; and a handle portion coupled to the carriage portion, the handle portion is coupled to the carriage portion, the handle portion facilitating pushing the system.

U.S. Pat. No. 6,584,937 describes a kennel stroller affords safe, convenient and comfortable transport of small pets. The stroller is designed to receive both in-cabin kennels or ordinary baggage check-in kennels which are placed in areas specified for live animals on airlines. A foldable stroller of the type used for baby strollers is slightly modified to provide an internal open volume sufficient to receive the portable kennel. Retained to the stroller frame by a strap or other fastener, the kennel can be used as an open pet bed, without cover, or as a covered, complete kennel.

However, the above publications either addresses the specific, non-generic use or needs of a particular situation such as air transporting a pet via an airplane, or the devices are bulky and not easily maneuverable. Another known pet moving bag is depicted in FIGS. 1 and 2. Referring to FIGS. 1 and 2, a carrying vehicle 1, and a semi-soft bag 2.

Vehicle 1 comprises a pair of parallely connected front support 11, and a pair of rear support 12. A handle 13 is formed out of frond support 11. A set of wheels 14 is attached onto front support 11 and rear support 12 respectively. A coupling member 15 couples frame 16 and the relevant above members together as shown.

Bag 2 has an opening 21, a contained inner space 22, and a bag body 23. Bag 2 further includes a zip 24 for zipping the upper cover 25. Bag 2 further has an extension 26 located at the upper portion of bag body 23. A Velcro member 27 extends further out of the extension 26 and is adapted to fold back bag 2 onto frame 16. This way, bag 2 is hang onto cart I via the Velcro 27 of bag 2.

While the above prior art pet cart may serve the purpose in carry pets, but the soft bag 2 may be easily deformed and changes shape due to factors such as the weight of the pet bag 2 carries. This is especially true if the carrying bag 2 is disengaged from the cart 1 and carried about by users or pet owners. Because after bag 2 has been independently carried about, this makes the bag 2 back into the cart 1 ascetically unpleasing to the eye due to its deformity. In addition, using Velcro member 27 tends to lower the usable life span of the device and also using Velcro member 27 may sometimes be very inconvenient.

Therefore, it is desirable to have a pet carriage that is more solid in structure, ascetically pleasant, and having a sustainable, useable life span.

### SUMMARY OF THE INVENTION

A pet carriage that is easily assembled and disassembled is provided.

A pet carriage that is not easily deformed is provided.

A pet carrying apparatus in which a pet can get in or out of a bag structure easily by itself is provided. The bag structure has a definite inner space defined by a bag body, a positioning frame that is positioned on a periphery the bag body, and a front layer defining a pet opening therein, whereby a pet can get in or out of the inner space. The apparatus further has a vehicle body that defines a vehicle inner space. The vehicle body has a frame and a set of attached wheels. The apparatus also has a pair of connecting devices positioned opposite of each other. Each of the connecting devices being located at an inner side of the vehicle body such that when the bag structure is placed within the vehicle inner space, the pair of connecting devices is symmetrically placed on the positioning frame.

### BRIEF DESCRIPTION OF THE DRAWING

FIG. 1 shows is a perspective view of a prior art pet cart.

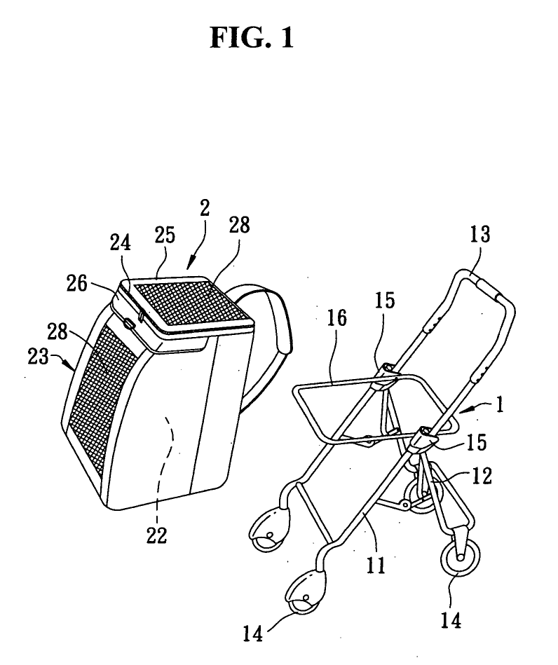

FIG. 2 shows a partial view of the prior art pet cart of FIG. 1.

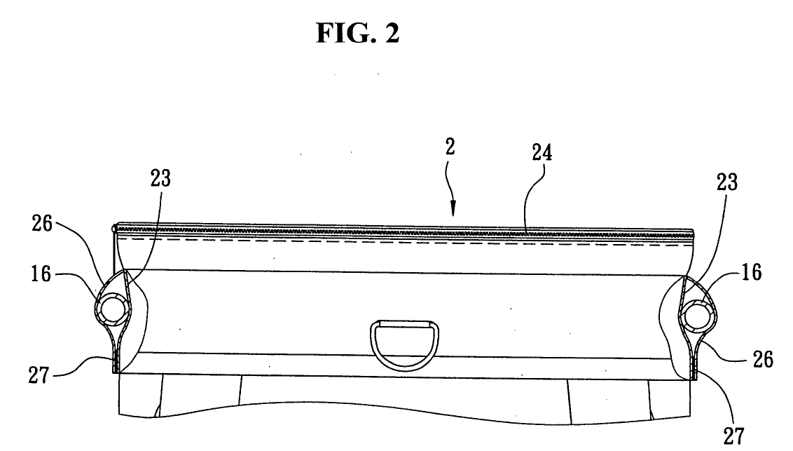

FIG. 3 shows a perspective view of the present invention.

FIG. 4 shows a three dimensional sectional view of the present invention.

FIG. 5 shows a sectional view of the present invention.

FIG. 6 shows a plain view of a coupling device of the present invention.

FIG. 7 shows the plain view of the coupling device of FIG. 6 with depictions of the coupling.

FIG. 8 shows a sectional view depicting a connection of the present invention.

FIG. 9 shows is a three dimensional view of the present invention.

FIG. 10 shows is a partial section view of the present invention.

FIG. 11 shows is side view of the present invention.

FIG. 12 shows a partial sectional view of a second embodiment of a coupling device of the present invention.

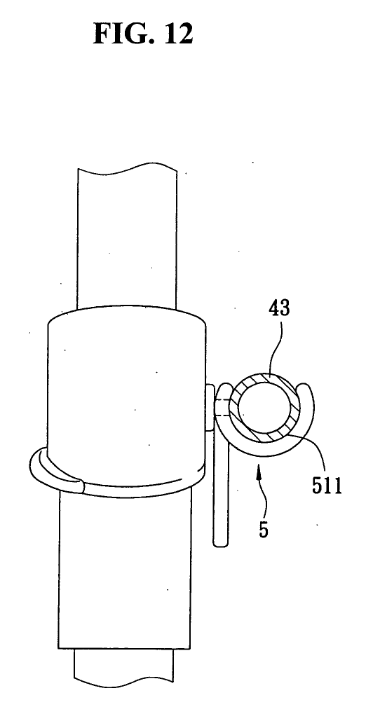

FIG. 13 shows a perspective view including one of the pair of the coupling members of the present invention.

FIG. 14 shows a blow up view of one of the pair of the coupling members of the present invention.

FIG. 15 shows a sectional view of one of the pair of the coupling members of the present invention when the bag structure and the vehicle is engaged.

FIG. 16 shows a sectional view of one of the pair of the coupling members of the present invention when the bag structure and the vehicle is disengaged.

### DETAILED DESCRIPTION OF THE INVENTION

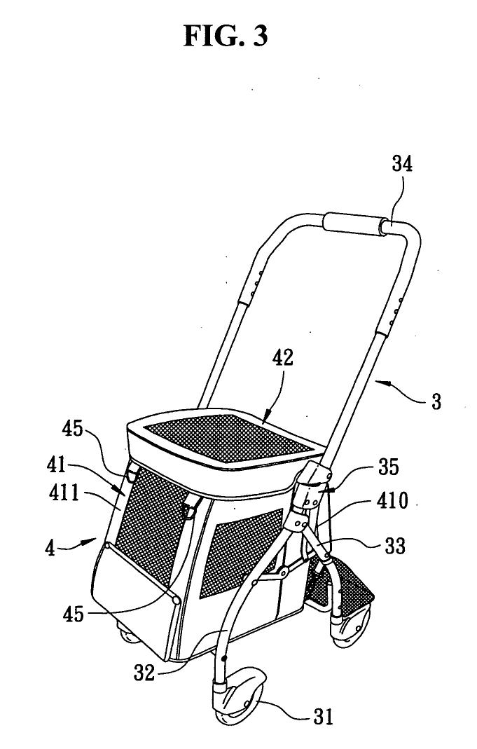

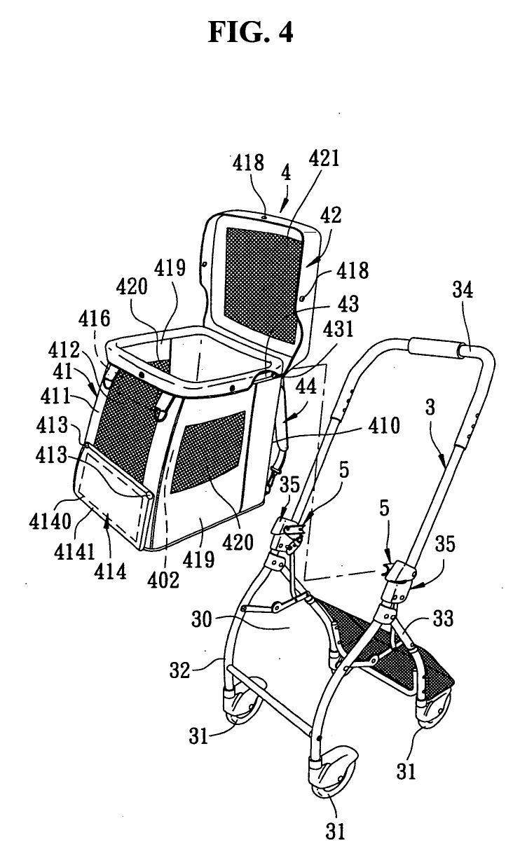

Referring to FIGS. 3 and 4, a first embodiment of the present invention is shown. The first embodiment includes a vehicle structure 3, a bag structure 4, and a connecting device 5.

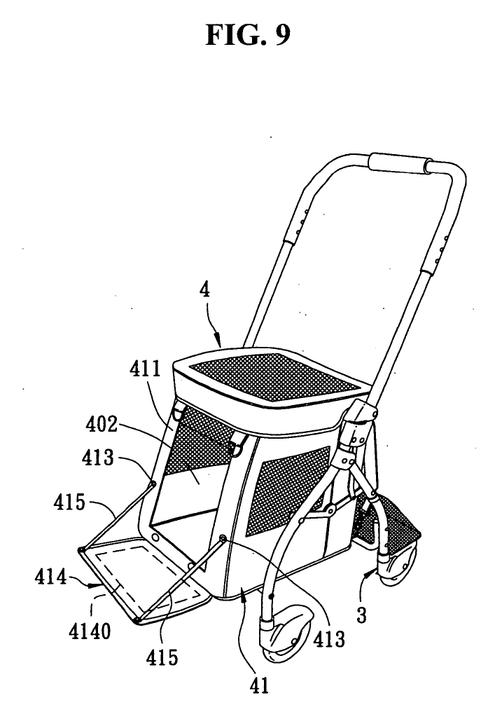

Bag structure 4 has an opening 401 and an inner volume 402 defined by the enclosure of the bag body 41. Bag structure 4 also defines a top portion 42 covering an opening 401 of bag 4. Bag structure 4 further defines a positioning frame 43 on the periphery of opening 401. Bag structure 4 also has a pair of straps 44 connected thereto at the rear surface 410 of bag body 41. A front net layer 412 adapted to opening or closing at the front surface 411 is formed on the bag body 41. Bag body 41 also has a protection layer 414 that is disposed between front surface 411 and bottom surface 413. Protection layer 414 is sealed at the base end of front net layer 412. A solid plate 4140 is disposed within protection layer 414 (see FIG. 4 as well as FIG. 9). Within protection layer 414, there are disposed various elements including a pair of strings 415 of substantially equal length is disposed between the front surface 41 land inner bag 416. Various male fixers 417 and female fixers 418 are disposed to connect lateral side 419 with lateral net layer 420. Furthermore, top portion 42 has a ventilation layer 421 formed thereon.

Vehicle structure 3 comprises carrying space 30 and a plurality of wheels 31 coupled thereon. Vehicle structure 3 further comprises a front portion 32 and rear portion 33. Vehicle structure 3 also comprises a handle 34 formed at the top of front portion 32; and structure 3 further has a coupling member 35 that couples together the front portion 32 and the rear portion 33.

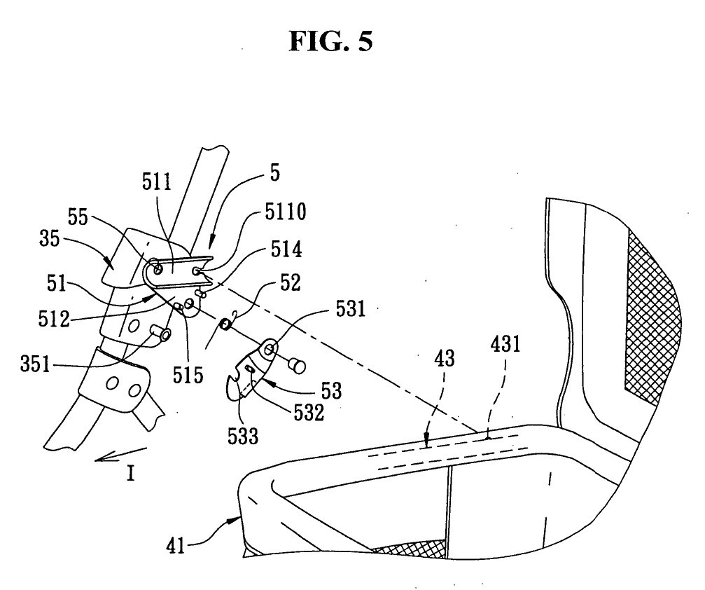

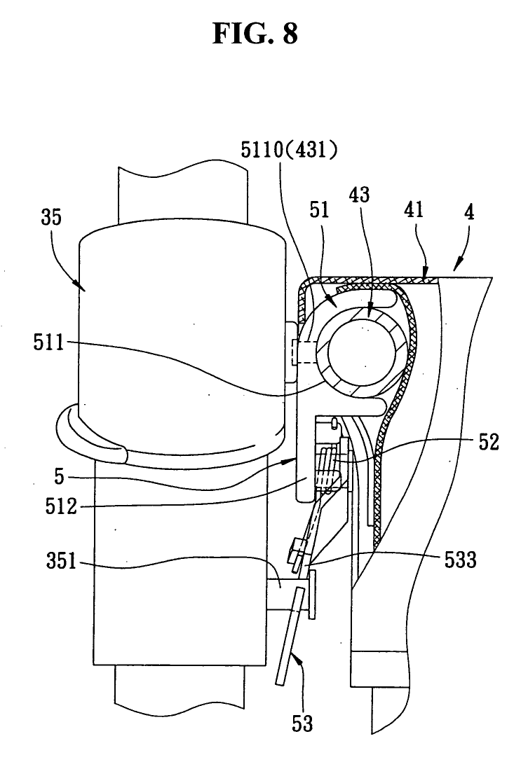

Referring to FIGS. 5-6, and 8, connecting device 5 is described. Device 5 comprises a connecting member 51 disposed at the inner side of coupling member 35. Connecting member 51 is disposed to be coupled to hooking member 53 and onto coupling member 35. Connecting member 51 has a “U shaped trough element 511, a bracket 512 at its base portion. Connecting member 51 further has an aperture 513, and a first column 514 for going through aperture 513, as well as a second column 515. Hooking member 53 has a corresponding aperture 513. A nipple 532 is provided that is formed by such mechanical process as stamping. A hook 533 is disposed between coupling member 35 and latch 351. Concave trough 511 has a radius reducing opening 5110 at its end. When bag body 41 and positioning frame 43 are fit onto concave trough 511 along a first direction, and bag body 41 drawn along a second direction (not shown), the connecting member 431 of positioning frame 43 can fit into radius reducing opening 5110. As a result, bag body 41 fits snugly between the connecting device 5 of vehicle structure 3.

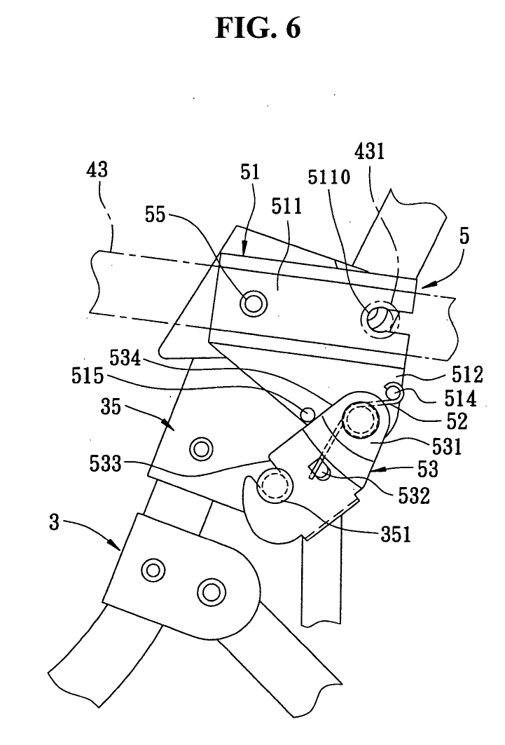

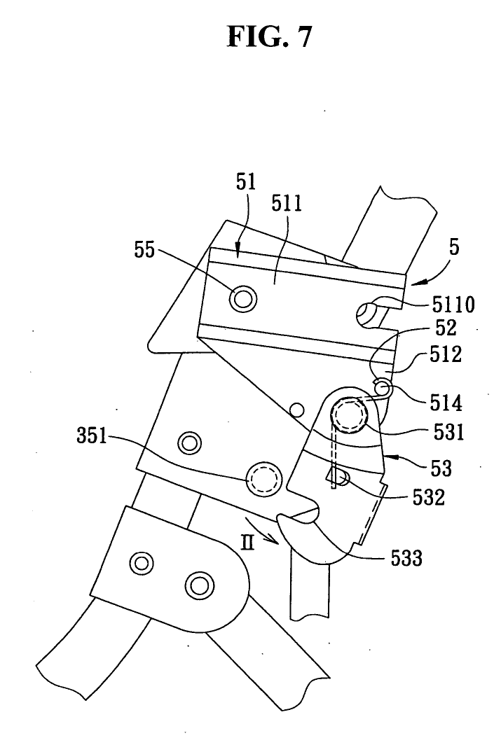

Referring to FIGS. 6 and 7, due to the facts that connecting member 51 merely use bolt 55 for fastening onto coupling member 35, that torsion spring 52 on riveting member 54 has both ends disposed between first column 514 and nipple 532, therefore, during installation, the hook 533 of hooking member 53 moves against direction II and fit into 315 and at the same time stopped by second column 515. This way, connecting device 5 fits securely onto vehicle structure 3, and bag structure 4 is secured.

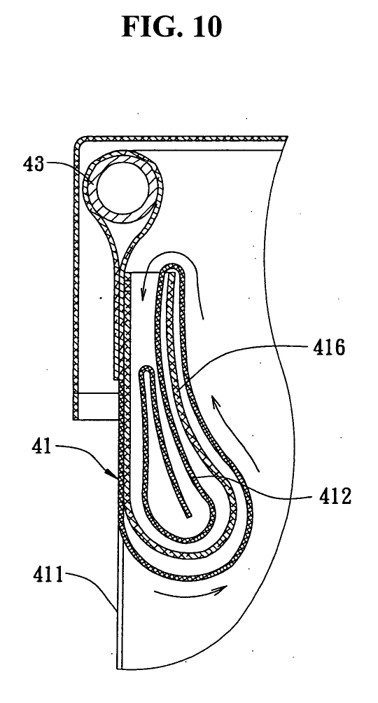

Referring to FIGS. 9 and 10, when moving a pet into bag 4, due to the fact that bag body 41 is elevated by vehicle structure 3 to above-ground level, protection layer 414 may be flipped open and used as a ramp for a pet to access the inner volume 402 of bag 4. The opening of the protection layer 414 is limited by the length of string 415. Note that front net layer 412 may be folded into inner bag 416.

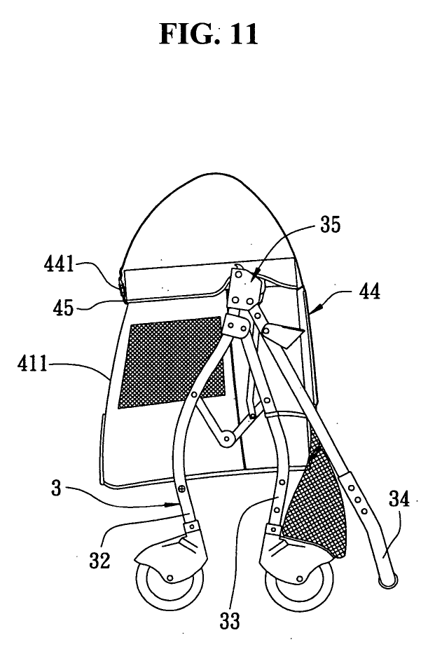

Referring to FIGS. 3 and 11, when vehicle structure 3 is not carrying a pet, coupling member 35 can fold handle 34 behind rear portion 33. Further, a hook member 441 is formed on bag body 41 and may be affixed on a set of rings 45 in the bag body. This way, belt 44 can be used to carry this pet carriage.

As can be seen, the pet carriage of the present invention uses the connecting device 5 of coupling member 35 on vehicle structure 3 for fitting bag body 41 in place. Positioning frame 43 is fit onto the corresponding concave trough 511. Connecting member 431 is fit into radius reducing opening 5110, thereby achieving efficient positioning in assemblage. When disassembling the pet carriage, connecting member 431 is unlatched from radius reducing opening 5110, in turn positioning frame 43 disengaged from concave trough 511, thereby achieving disassembling.

Compared to prior art devices, the present invention is more structurally stable and secure. Further, by affixing positioning frame 43 on bag structure 4 make the same more solid and stay in shape than the prior art bag device which does not have this solidity because it is hanging downwards. The bag structure 4 of the present invention possesses a solid form due to its plurality of layers, therefore even when it is disengaged from vehicle structure 3, it still gives a pet contained therein a more comfortable containing space. In addition, the present invention has the advantage of the ease of assembling and dis-assembling, accurate positioning, and sustainable to prolonged usage.

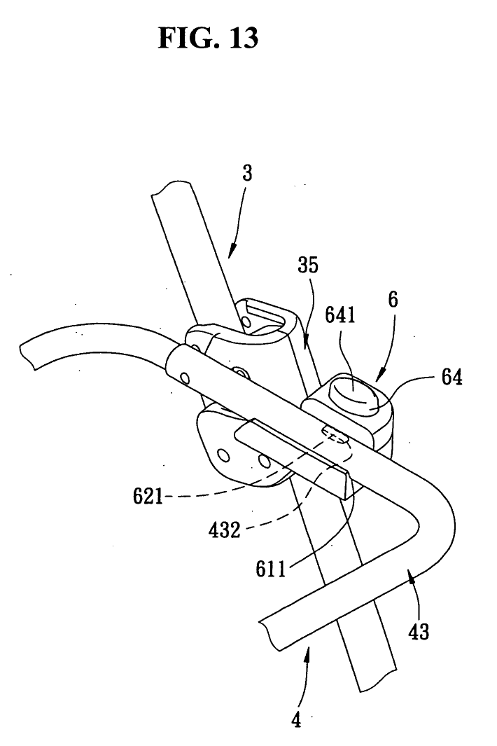

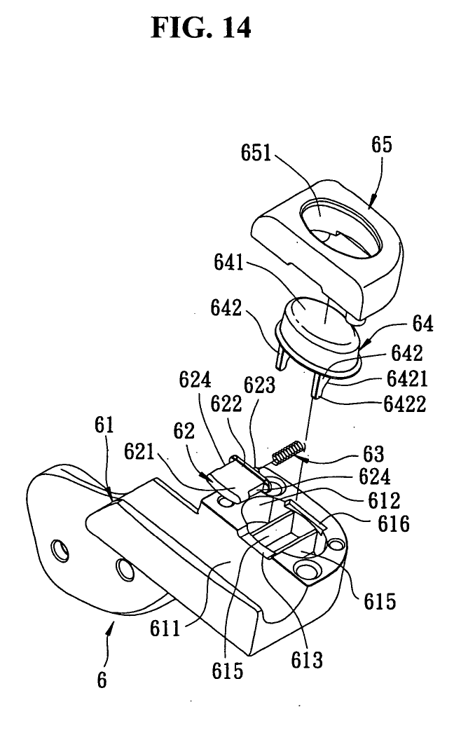

Referring to FIGS. 13 and 14, an alternate embodiment of the present invention is shown. The alternate embodiment includes a vehicle structure 3, a bag 4, and a locking device 6.

Referring again to FIG. 4, it can be seen that the vehicle structure 3 and the bag structure 4 are substantially similar in structure as the preferred embodiment except a opening 401 of bag body 41 positioned about positioning frame 43. Referring again to FIGS. 13 and 14, the positioning frame 43 further comprises a pair of fastening apertures 432 (only one shown in FIG. 13) on 430.

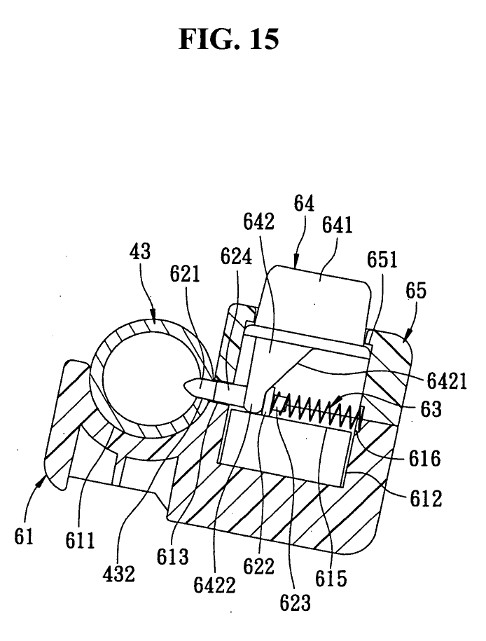

Referring to FIGS. 14 and 15, the locking device 6 is shown. Locking device 6 comprises a base 61, a positioning latch 62, an elastic element 63, an operating element 64, and a top 65.

Base 61 has a positioning trough 611 which has a reversed “U shape along 430 of positioning frame 43. A convex member 612 is formed on positioning trough 611. A lead 613 exists between positioning trough 611 and convex member 612. Coupling member 35 further comprises a pair of apertures (not shown) mashing with positioning trough 611 as well as the pair of riveting member 54 onto vehicle structure 3. Base 61 further has a pair of supporting board 615 each of which has the same height disposed within 616. Locking device base 61 also has a convex shaped opening (not shown) formed on the periphery of convex member 612.

Positioning latch 62 possesses a latch tip 621 positioned on lead 613, a stopping ridge 622 positioned on the opposite side of latch tip 621 and having somewhat wider formation than latch tip 621, and a protruding block 623 positioned at the center portion of the opposite side of latch tip 621. An engaging groove 624 is positioned at both sides of latch tip 621. Engaging groove 624 is adjacent to stopping ridge 622.

The elastic element 63 has a first end engaging protruding block 623, which causes elastic element 63 to be disposed between latch tip 621 and leading convex member 616.

Operating element 64 has an operating portion operating portion 641. A pair of convex members 612 accommodates the movement of operating portion 641. A pair slidable engaging members 642 is formed out of operating portion 641 and extends onto convex member 612 for engaging groove 624. Engaging groove 624 has a ramp 6421, and a stopper 6242.

Top portion 65 has a hollow space corresponding to base 61. Top 65 also has a graded opening 651 for operating portion 641 to move within the same.

Locking device 6 is assembled as follows: positioning latch 62 is placed upon lead 613, and stopping ridge 622 is positioned onto supporting board 615. The elastic element 63 is connectively engaged between 616 and stopping ridge 622. In turn, using the stopping portion 6422 on slidable engaging member 642 of operating element 64, connect the convex column 652 of top 65 onto a convex opening (not shown) of base 61. This way, operating portion 641 extends into graded opening 651.

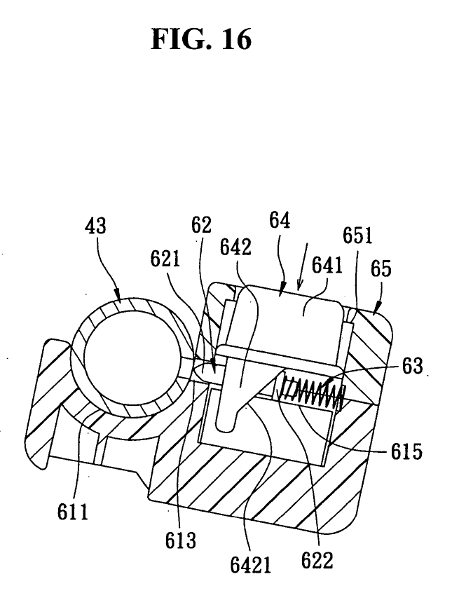

Referring to FIGS. 13 and 16, when the locking device 6 is affixed onto the coupling member 35 of vehicle structure 3, in order to install bag structure 4 on positioning frame 43 thereby connecting the bag structure 4 onto vehicle structure 3, one needs to press operating portion 641 downwards. As operating portion 641 is being pressed downwards, operating element 64 via the ramp shape of slidable engaging member 642, i.e. ramp portion 6421 pushes the stopping ridge 622 of positioning latch 62. The stopping ridge 622 slidably moves along the top portion of supporting board 615, thereby compressing elastic element 63. Latch tip 621 in turn retracts back into lead 613 from positioning trough 611. At this juncture, tip 621 can be placed onto positioning trough 611, thereby locking the bag structure 4 onto vehicle structure 3 as shown in FIG. 15. When operating portion 641 is relieved from the downward pressure, elastic element 63 extends outward, and latch tip 621 of positioning latch 62 extends once more into positioning trough 611 and engages into fastening aperture 432 of positioning frame 43, as shown in FIG. 13. This way, coupling member 35 installs bag structure 4 onto vehicle structure 3 and achieves similar results as that of the preferred embodiment.

As can be appreciated, the present invention is easy to install and disassemble, as well as durable. Further, the present invention can position its various parts securely onto each other, and can further maintain its shape upon sustained usage.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A pet carrying apparatus, comprising:
a bag structure having a definite inner space defined by a bag body, a positioning frame that is positioned on a periphery the bag body, and a front layer defining a pet opening therein, whereby a pet can get in or out of the inner space;
a vehicle body defining a vehicle inner space, the vehicle body having a frame and a set of wheels coupled thereto; and
a pair of connecting devices positioned opposite of each other and each of the connecting devices being located at an inner side of the vehicle body such that when the bag structure is placed within the vehicle inner space, the pair of connecting devices is symmetrically placed on the positioning frame.

2. The pet carrying apparatus of claim 1, wherein each of the pair of connecting devices further comprising a coupling member for coupling the bag structure to the positioning frame.

3. The pet carrying apparatus of claim 2, wherein the coupling member has a “U shaped trough.

4. The pet carrying apparatus of claim 1, wherein the bag structure has a ramp member positioned at the front side of the bag structure, the ramp member having a substantially rectangular shape with one side connect to a line at a proximity of a juncture of a bottom portion of the bag structure and the front layer, and the three other sides of the rectangular shape being free from connecting any other member, the line further defines part of a bottom area of the pet opening, thereby the ramp member can use the line as a hinge for the same to flip away from the front side and used as a ramp for a pet to get in or out of the inner space.

5. The pet carrying apparatus of claim 1, wherein the bag structure comprising an inner bag disposed at an inner portion of the bag structure.

6. The pet carrying apparatus of claim 1, wherein the bag structure comprises a top opening portion.

7. The pet carrying apparatus of claim 1, wherein each of the pair of connecting devices comprises a pressable engaging latch for latching the bag structure onto the vehicle body.
